(19) United States
(12) Patent Application Publication
(10) Pub. No.: US 2020/0130245 A1
(43) Pub. Date: Apr. 30, 2020

(54) Glass Molded Product

(71) Applicant: Futaba Corporation, Mobara-shi (JP)

(72) Inventor: Takashi INOUE, Mobara-shi (JP)

(21) Appl. No.: 16/600,077

(22) Filed: Oct. 11, 2019

(30) Foreign Application Priority Data
Oct. 24, 2018 (JP) 2018-200008

(51) Int. Cl. B29C 45/14; G02F 1/1333

(52) U.S. Cl. CPC B29C 45/14434; B29K 2075/00; G02F 1/133308

(57) ABSTRACT

A glass molded product has a plate-like glass 1b having a convex portion provided on the outer peripheral end face, and a resin frame integrally molded to cover the convex portion. The convex portion has a front side pressure receiving surface having a small pressure receiving area and a back side pressure receiving surface having a large pressure receiving area from the resin during integral molding. At the time of integral molding, the plate-like glass is pressed against the upper mold by the resultant force of resin pressure. Even if the lower mold is movable according to the variation of the thickness of the plate-like glass, at least the surface of the plate-like glass does not have a step with the frame, and at least the front side of the glass molded product becomes flat.

### TECHNICAL FIELD

The present invention relates to a glass molded product in which a resin frame is integrally formed on an outer peripheral end face of a plate-like glass, In particular, relates to a glass molded product having no step at the boundary between the plate-kike glass and a frame.

### BACKGROUND ART

Patent Literature 1 below describes an invention of a glass article having an outer coating of a polymer and a method of forming the same. This glass article comprises a molded glass substrate including a first surface, a second surface, and a peripheral edge. This molded glass substrate is formed of tempered glass with a compressive stress layer that resists surface damage without forming cracks. The outer coating of the polymer is connected with the connection mechanism of the peripheral edge of the molded glass substrate, thereby protecting the peripheral edge of the molded glass substrate from damage. At least a portion of the peripheral edge of the molded glass substrate may be provided with an offset of the connection mechanism from the first surface. Further, the outer coating of the polymer is intended to be integrally formed with at least one connector.

### PRIOR ART DOCUMENT

### Patent Literature

Patent Literature 1: JP 2012-526040 A

### SUMMARY OF INVENTION

### Technical Problem

The glass article described in Patent Literature 1 is a panel-like product in which an outer coating of a polymer is connected to the peripheral edge of a molded glass substrate as described above. However, on at least one of the front side and the back side of the product, a large step was generated between the molded glass substrate and the outer coating. It is preferable to eliminate the step because the step on the front side reduces the appearance as a product, and the step on the back side is an obstacle when attaching devices such as a touch sensor, or when attaching to a substrate or frame on which the glass article is attached.

Therefore, as shown in FIG. 1, the inventor of the present application has proposed a novel glass molded product 3a in which a resin frame 2 is integrally formed on the outer peripheral end face of a rectangular plate-like glass 1a and both front and back surfaces are flat. FIG. 1 is a cross-sectional view of a molding process showing a state in which the plate-like glass 1a is placed in the mold 4 and positioned by the pin 7, and then the mold 4 is closed to inject resin into the internal cavity.

Incidentally, the mold 4 has an upper mold 5 and a lower mold 6, and the upper mold 5 and the lower mold 6 can be opened and closed relatively in the vertical direction. The lower mold 6 is divided into an outer mold 6a and an inner mold 6b on which the plate-like glass 1a is placed. At the boundary between the outer mold 6a and the inner mold 6b, a positioning pin 7 which can freely slide out into the inside of the mold 4 is provided in order to position the plate-like glass 1a. The inner mold 6b is an adjusting member provided to allow variations in the thickness of the plate-like glass 1a, and can be moved up and down as indicated by the arrow A. Under the inner mold 6b, a buffer material 8 such as a spring or a urethane material is provided. In addition, illustration of the detailed structure etc. of each part including the guide mechanism and drive mechanism which guide the movement of each part of the mold 4 is omitted. According to this mold 4, when the plate-like glass 1a is thicker than expected, and when the plate-like glass 1a receives the clamping pressure of the mold 4, the buffer material 8 is retracted to lower the inner mold 6b together with the plate-like glass 1a.

The glass molded product 3a shown in FIG. 1 proposed by the inventor of the present application is characterized in that there is no difference in level between the plate glass 1a and the frame 2 and both the front and back surfaces are flat. In order to realize such a structural feature, the convex portion 10a is provided on the outer peripheral end face of the plate-like glass 1a, and the convex portion 10a is covered with the integrally molded resin using the mold 4 described above. Thus, the frame 2 is held only by the outer peripheral end face of the plate-like glass 1a. In this case, the convex portion 10a passes through the center in the thickness direction of the plate-like glass 1a, and is vertically symmetrical with respect to a center line parallel to the front surface 11a and the rear surface 11b. In the example shown, it becomes an equal chamfering shape which cut the vertex of the isosceles triangle by the surface perpendicular to the surface 11a. That is, the corners on the front surface side and the corners on the back surface side are chamfered shapes having the same depth at an angle of 45 degrees.

However, in the case of manufacturing the glass molded product 3a in which the frame 2 is held only by the convex portion 10a using such a mold 4 and the front surface 11a and the back surface 11b are flat, the inventor of the present application has found another new problem to be solved. That is, even if the glass molded product 3a mentioned above is going to be manufactured with the metal mold 4 mentioned above, it is not necessarily the case that the glass molded product 3a is flat on both front and back as shown in FIG. 1. As shown by the reference sign B in FIG. 2, on the surface 11a of the glass molded product 3a, resin burrs are formed at the boundary between the plate-like glass 1a and the frame 2 and a step is generated.

During injection molding shown in FIG. 1 and FIG. 2, the pressure of the resin in the mold 4 is applied to the convex portion 10a of the plate-like glass 1a in both the upper and lower directions as indicated by arrows C and D in FIG. 1 and also applied to the inner mold 6b as indicated by arrow E. The forces in the two directions (arrows C and D) applied to the convex portion 10a of the plate-like glass 1a have the same magnitude in opposite directions, and therefore the resultant force does not move the plate-like glass 1a in the vertical direction. However, the force (arrow E) applied to the inner mold 6b may cause the inner mold 6b to move downward against the elastic force of the buffer material 8 as shown in FIG. 2. Thereby, a gap is generated between the surface 11a of the plate-like glass 1a and the upper mold 5, and the resin enters the gap as described above, and resin burrs are formed at the boundary between the plate-like glass 1a and the frame 2 to cause a step.

The present invention, as described above, is an invention in which the invention of the inventor of the present application for solving the problems of the prior art is further improved in order to solve the further problems known to the inventor of the present application. In a novel glass molded product in which a resin frame is provided by integral molding on the convex portion of the outer peripheral end face of a plate-like glass and at least its surface is flat, it is an object of the present invention to eliminate resin burrs generated at a boundary between a front side of the plate-like glass and a frame and to at least make its surface flat.

### Solution to Problem

According to a first aspect of the present invention, there is provided a glass molded product comprising:
a plate-like glass with a convex portion on an outer peripheral end face; and
a frame made of a resin provided by integral molding to cover the convex portion,
wherein front surfaces of the plate-like glass and the frame are on the same plane, and back surfaces of the plate-like glass and the frame are on the same plane, and
wherein the convex portion is shaped such that a resultant force of pressure received from the resin during the integral molding is directed to the front surface of the plate-like glass.

According to a second aspect of the present invention, there is provided the glass molded product as described in the first aspect,
wherein the convex portion includes:
a front side pressure receiving surface having a relatively small area for receiving the pressure of the resin during the integral molding; and
a back side pressure receiving surface having a relatively large area for receiving the pressure of the resin during the integral molding.

### Effect of the Invention

According to the glass molded product as described in the first aspect, when providing a resin-made frame by integral molding in the convex portion provided in the outer peripheral end surface of the plate-like glass, the resultant force of the pressure from the resin added to a convex portion goes to a surface of the plate-like glass. For this reason, even when using a mold in which the mold is movable in order to cope with the variation in thickness of the plate-like glass, at least the surface of the plate-like glass does not have burrs and steps with the frame, and at least the front side of the glass molded product can be made flat. Further, depending on the conditions, burrs and steps can be simultaneously eliminated also on the back surface of the plate-like glass, and the back side of the glass molded product can be made flat.

According to the glass molded product as described in the second aspect, the convex portion provided on the outer peripheral end face of the plate-like glass includes: a front side pressure receiving surface having a relatively small area for receiving the pressure of the resin during the integral molding; and a back side pressure receiving surface having a relatively large area for receiving the pressure of the resin during the integral molding. Therefore, the action of directing the resultant force of the pressure from the resin applied to the convex portion at the time of integral molding to the surface of the plate-like glass can be reliably obtained.

### BRIEF DESCRIPTION OF DRAWINGS

FIG. 1 is a cross-sectional view showing a glass molded product which the inventor of the present application proposed, a mold for manufacturing the same, and a process of manufacturing the glass molded product using this mold;

FIG. 2 is a cross-sectional view showing a glass molded product which the inventor of the present application proposed, a mold for manufacturing the same, a process of manufacturing the glass molded product using this mold, and a problem found in this;

FIG. 3 is a cross-sectional view showing a step of placing the plate-like glass 1 in a mold in the process of manufacturing a glass molded product according to a first embodiment of the present invention;

FIG. 4 is a cross-sectional view showing a step of injecting a resin into a mold in the process of manufacturing a glass molded product according to the first embodiment of the present invention;

FIG. 5 is a cross-sectional view showing a step of injecting a resin into a mold in the process of manufacturing a glass molded product according to a second embodiment of the present invention;

FIG. 6 is a cross-sectional view showing a step of injecting a resin into a mold in the process of manufacturing a glass molded product according to a third embodiment of the present invention; and

FIG. 7 is a cross-sectional view showing a step of injecting a resin into a mold in the process of manufacturing a glass molded product according to a fourth embodiment of the present invention.

### DESCRIPTION OF EMBODIMENTS

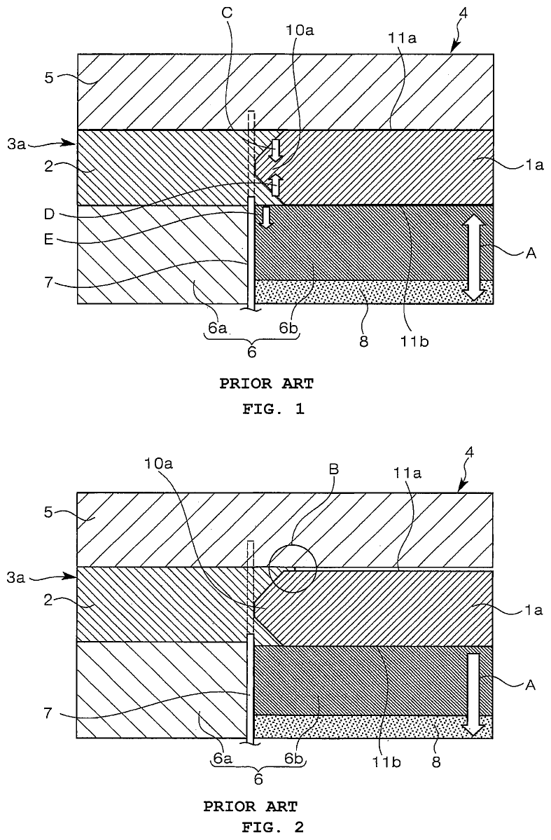

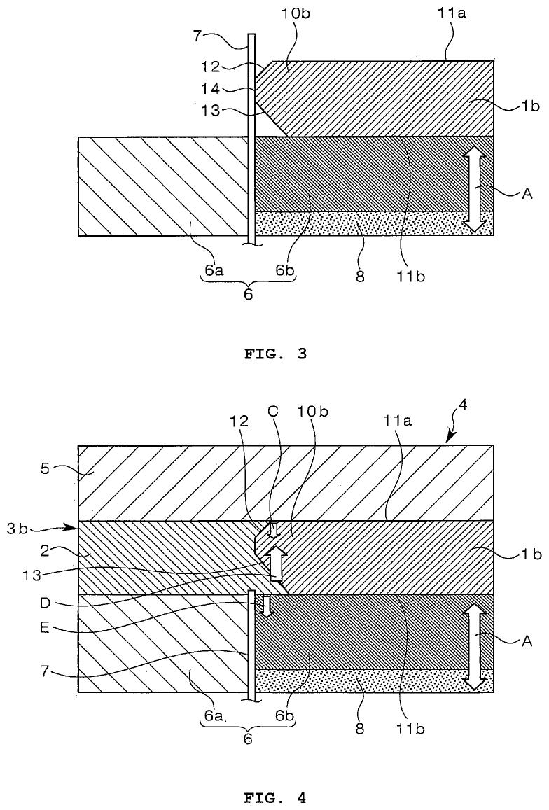

The glass molded products 3b to 3e according to first to fourth embodiments of the present invention will be described with reference to FIGS. 3 to 7. The glass molded products 3b to 3e of these embodiments are panel-shaped products in which resin-made frames 2 are provided on outer peripheral end faces of rectangular plate-like glasses 1b to 1e by integral molding using molds. These molded glass products 3b to 3e can be used as a cover glass for covering devices which are components in various apparatuses. For example, a touch sensor may be disposed on the back side of the molded glass products 3b to 3e to constitute an input device. A liquid crystal display can be arranged to constitute a display device. However, the application is not limited. incidentally, the drawings showing these embodiments are the same as FIGS. 1 and 2 showing the previous invention of the inventor of the present application, and cross-sectional views in which the vicinity of the boundary between the plate-like glass 1b to 1e and the frame 2 is cut by a cut surface parallel to the opening/closing direction of the mold 4.

A glass molded product 3b according to the first embodiment of the present invention will be described with reference to FIGS. 3 and 4. As shown in FIGS. 3 and 4, the convex portion 10b is provided in the outer peripheral end face of the plate-like glass 1a of the glass molded article 3a as a structure for fixing the frame 2. The convex portion 10b has a front side pressure receiving surface 12 formed by chamfering having an inclination angle of about 50 degrees with respect to the front surface, a rear side pressure receiving surface 13 formed by chamfering having an inclination angle of about 50 degrees with respect to the rear surface, and a vertical surface 14 provided on the boundary between the front pressure receiving surface 12 and the rear pressure receiving surface 13 so as to be perpendicular to the front surface 11a and the rear surface 11b. And the depth of the chamfering is deeper at the back side pressure receiving surface 13 than the front side pressure receiving surface 12, and is about twice. Therefore, the area of the rear side pressure receiving surface 13 is larger than the area of the front side pressure receiving surface 12. Further, the convex portion 10b of the plate-like glass 1a is polished by a relatively rough polishing means (for example, a whetstone of about #800 or the like), and asperities (not shown) are formed on the surface of the convex portion 10b.

When manufacturing the glass molded product 3b, the mold 4 is used. The mold for producing the glass molded product 3b is the same as the mold 4 used for producing the glass molded product 3a, which is the earlier invention of the inventor of the present application described with reference to FIGS. 1 and 2. First, as shown in FIG. 3, the positioning pin 7 is made to project above the lower mold 6, and the plate-like glass 1b is placed on the inner mold 6b of the lower mold 6 so that the front pressure receiving surface 12 faces up. Then, the vertical surface 14 of the convex portion 10b is abutted against the positioning pin 7 to determine the position of the plate-like glass 1b.

Next, as shown in FIG. 4, the upper mold 5 and the lower mold 6 are closed, and the positioning pin 7 is pulled into the lower mold 6. The tip of the positioning pin 7 may slightly protrude into the mold 4. Then, the molten resin is injected into the hollow of the mold 4 under a necessary pressure, and the plate-like glass 1b is inserted into the resin frame 2 to be integrally molded.

In the mold, the convex portion 10b is encased in a resin, and the molten resin enters the fine asperities on the surface of the convex portion 10b to be solidified, and an anchor effect is obtained in which the frame 2 is reliably fixed to the convex portion 10b. The frame 2 is stably held only by the convex portion 10b of the plate-like glass 1b.

In such an integral molding process, the pressure of the molten resin in the mold 4 is applied to the convex portion 10b. The upward component force (arrow D) of the force applied to the rear pressure receiving surface 13 is larger than the downward component force (arrow C) of the pressure applied to the front pressure receiving surface 12. Therefore, the plate-like glass 1b provided with the convex portion 10b is pushed up as a whole by the force corresponding to the difference between the upward component force and the downward component force. Therefore, the surface 11a of the plate-like glass 1a is in close contact with the lower surface of the upper mold 5. Therefore, the problem described above with reference to FIG. 2, that is, in the production of the glass molded product 3a proposed by the inventor of the present application, the inner mold 6b is sunk by the resin pressure to form a gap (reference sign B) between the surface 11a of the plate-like glass 1a and the lower surface of the upper mold 5 and a step is generated between the plate-like glass 1a and the frame 2 (or burrs can be made on the relevant part), does not occur at all in the first embodiment, and at least the flatness on the surface 11a side of the glass molded product 3b is reliably ensured.

Although the back surface side of the glass molded product 3b depends on the type of the product using the glass molded product 3b as a component, the back surface 11b which is generally the inner side of the apparatus is not required to have a finish as accurate as the front surface 11a. Therefore, as described above, it is often sufficient to obtain high-precision flatness on the front surface 11a side. Also, if the resin pressure and the elastic force of the buffer material 8 are set to appropriate values, the sinking of the inner mold 6b due to the resin pressure can be avoided or at least reduced. Therefore, it is also possible to make both the front surface 11a and the back surface 11b of the glass molded product 3b flat with the required accuracy.

In this manner, at least on the front surface 11a, a flat structure having no step between the plate-like glass 1b and the frame 2 is obtained. Incidentally, it is preferable that this flatness is a grade which does not feel a level difference when touching with a finger. As an example for that, the step between the plate-like glass 1b and the frame 2 should just be about 20 micrometers or less, and this condition can be cleared in the first embodiment.

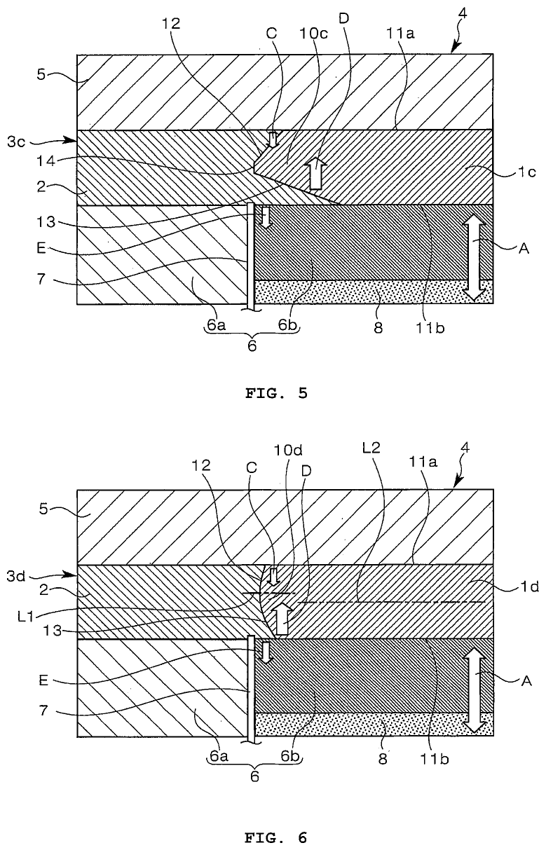

A glass molded product 3c according to a second embodiment of the present invention will be described with reference to FIG. 5. The glass molded product 3c of the second embodiment is different from the first embodiment in the shape of the convex portion 10c of the plate-like glass 1c. Others are substantially the same as the first embodiment in structure and manufacturing method. As shown in FIG. 5, the convex portion 10c of the plate-like glass 1c is configured by a front pressure receiving surface 12 formed by chamfering having an inclination angle of about 50 degrees with respect to the surface 11a, a rear pressure receiving surface 13 formed by chamfering having an inclination angle of about 20 degrees with respect to the back surface 11b, and a vertical surface 14 provided on the boundary between the front pressure receiving surface 12 and the rear pressure receiving surface 13 so as to be perpendicular to the front surface 11a and the back surface 11b. In addition, the chamfering depth of the rear side pressure receiving surface 13 is three times or more of the chamfering depth of the front side pressure receiving surface 12. Accordingly, the area of the rear side pressure receiving surface 13 is larger than that of the front side pressure receiving surface 12, and larger than the case in the first embodiment.

In the step of integral molding using the mold 4, the upward component force (arrow D) by the pressure applied to the rear pressure receiving surface 13 is larger than the downward component force (arrow C) by the pressure applied to the front pressure receiving surface 12 and larger than the case of the first embodiment. Therefore, the action of the plate-like glass 1c being pushed upward and in close contact with the lower surface of the upper mold 5 is even more sure than in the first embodiment. The flatness (smallness of the step) of at least the surface 11a of the glass molded product 3c is higher than that of the first embodiment.

A glass molded product 3d according to a third embodiment of the present invention will be described with reference to FIG. 6. The glass molded product 3d of the third embodiment differs from the first and second embodiments in the shape of the convex portion 10d of the plate-like glass 1d. Others are substantially the same as the first embodiment in structure and manufacturing method. As shown in FIG. 6 which is a cross sectional view, the convex portion 10d of the plate-like glass 1d is represented by a part of a circle. This shape is constituted by a part of a cylindrical surface continuous in the direction perpendicular to the paper surface of FIG. 6. A line L1 passing through the center of this circle and parallel to the front surface 11a and the back surface 11b is at a position closer to the surface 11a than the line L2 passing through the center in the thickness direction of the plate-like glass 1d and parallel to the front surface 11a and the back surface 11b. Therefore, the surface of the convex portion 10d is constituted by the front pressure receiving surface 12 located closer to the surface 11a than the line L1 and the rear pressure receiving surface 13 located closer to the back surface 11b than the line L1.

In the step of integral molding using the mold 4, since the upward component force by the pressure applied to the rear pressure receiving surface 13 (arrow D) is greater than the downward component force by the pressure applied to the front pressure receiving surface 12 (arrow C), the same effect as that of the first embodiment can be obtained according to the difference between the two component forces.

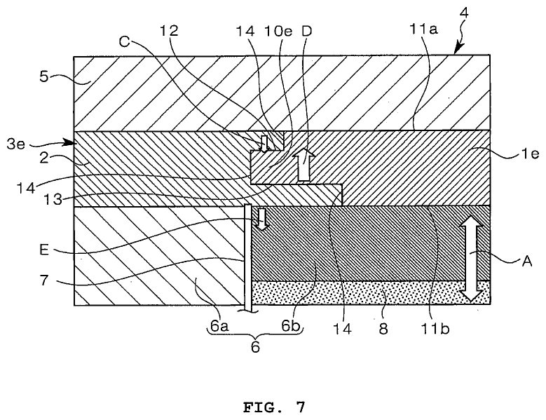

A glass molded product 3e according to a fourth embodiment of the present invention will be described with reference to FIG. 7. The glass molded product 3e of the fourth embodiment differs from the first to third embodiments in the shape of the convex portion 10e of the plate-like glass 1e. Others are substantially the same as the first embodiment in structure and manufacturing method. As shown in FIG. 7, the convex part 10e of the plate-like glass 1e is made into the rectangular shape which has steps in the upper and lower sides. That is, the surface 11a side of the convex portion 10e is formed by engraving a relatively small size rectangular shape, and the back surface 11b side of the convex portion 10e is formed by engraving a relatively large size rectangular shape. Therefore, the convex portion 10e is constituted by the front pressure receiving surface 12 parallel to the front surface 11a and the back surface 11b, the back side pressure receiving surface 13 parallel to the front surface 11a and the back surface 11b, and three vertical surfaces 14. The area of the rear side pressure receiving surface 13 is larger than the area of the front side pressure receiving surface 12.

In the step of integral molding using the mold 4, since the upward force by the pressure applied to the rear pressure receiving surface 13 (arrow D) is greater than the downward force by the pressure applied to the front pressure receiving surface 12 (arrow C), the same effect as that of the first embodiment can be obtained according to the difference between the two forces.

As explained above, according to each embodiment of the present invention, the front side pressure receiving surface 12 having a relatively small area and the rear side pressure receiving surface 13 having a relatively large area are provided on the convex portions 10b to 10e provided on the outer peripheral end faces of the plate-like glasses 1b to 1e. The plate-like glasses 1b to 1e are pushed up to the surface 11a side by the difference of the force in the vertical direction applied to both sides and brought into close contact with the upper mold 5. Thereby, while preventing the generation of burrs, at least on the surface 11a side, it is possible to prevent the step between the plate-like glasses 1b to 1e and the frame 2 and to obtain necessary flatness reliably.

### REFERENCE SIGNS LIST

1b-1e plate-like glass
2 frame
3b-3e glass molded product
4 mold
5 upper mold
6 lower mold
6a outer mold
6b inner mold
7 positioning pin
10b-10e convex portion
11a front surface
11b back surface
12 front side pressure receiving surface
13 back side pressure receiving surface
14 vertical plane

1. A glass molded product comprising:
a plate-like glass with a convex portion on an outer peripheral end face; and
a frame made of a resin provided by integral molding to cover the convex portion,
wherein front surfaces of the plate-like glass and the frame are on the same plane, and back surfaces of the plate-like glass and the frame are on the same plane, and
wherein the convex portion is shaped such that a resultant force of pressure received from the resin during the integral molding is directed to the front surface of the plate-like glass.

2. The glass molded product as claimed in claim 1,
wherein the convex portion includes:
a front side pressure receiving surface having a relatively small area for receiving the pressure of the resin during the integral molding; and
a back side pressure receiving surface having a relatively large area for receiving the pressure of the resin during the integral molding.
